(19) United States
(12) Patent Application Publication
(10) Pub. No.: US 2010/0260210 A1
(43) Pub. Date: Oct. 14, 2010

(54) OPS-LASER PUMPED FIBER-LASER

(75) Inventors: Luis A. SPINELLI, Sunnyvale, CA (US); Sergei V. Govorkov, Los Altos, CA (US); Andrea Caprara, Palo Alto, CA (US)

Correspondence Address: Coherent, Inc. c/o Morrison & Forester, 425 Market Street, San Francisco, CA, 94105-2482, US

(73) Assignee: Coherent, Inc., Santa Clara, CA (US)

(21) Appl. No.: 12/422,913

(22) Filed: Apr. 13, 2009

(51) Int. Cl. H01S 3/30

(52) U.S. Cl. 372/6

(57) ABSTRACT

An optical gain-fiber of a fiber-laser or a fiber-amplifier is optically pumped by radiation from a plurality of external cavity, optically pumped, surface-emitting semiconductor lasers (OPS-lasers). In one example, radiation from the OPS-lasers is focused by a lens into cladding of the gain-fiber at one end of the fiber. In another example radiation from the diode-lasers is focused into the core of a delivery fiber at one end of the delivery fiber. The other end of the delivery fiber is coupled to the cladding of the gain-fiber.

### TECHNICAL FIELD OF THE INVENTION

The present invention relates in general to fiber-lasers and fiber-amplifiers. The invention relates in particular optically pumping fiber-lasers and fiber-amplifiers with radiation from an array of diode-lasers.

### DISCUSSION OF BACKGROUND ART

Fiber-lasers, including fiber oscillator/amplifier combinations (MOPAs) are gradually replacing conventional solid-state lasers in several laser applications. Fiber-lasers and amplifiers have advantages over solid-state lasers in ruggedness and optical efficiency. CW fiber-lasers having a very simple architecture are capable of delivering a very high-powered beam, for example, a beam having a power in excess of 1 kilowatt (kW), in a single mode. Pulsed fiber-lasers can deliver peak-power as high as 10 kW or greater. Fiber-lasers can have an optical efficiency, for example between about 60% and 90%.

High-power CW fiber-lasers are extremely useful in material processing applications, such as cutting of complex 3D shapes found in hydro-formed automotive parts, and long-offset welding of complex shaped parts. High peak-power pulsed fiber-lasers with single mode output can be used for scribing of solar cell panels. Advantageously, high peak power enables efficient frequency conversion into visible and UV wavelength ranges.

In theory at least the output power of a fiber-laser is limited only by how much optical pumping power can be delivered into an optical gain-fiber for energizing a doped-core of the gain-fiber. In practice there are limits due, inter alia, to non-linear effects which can broaden the spectrum of pump radiation resulting in reduction of absorption efficiency, and photo-darkening of the fiber material which can lead to reduction of efficiency, excessive heating, and even catastrophic failure. The non-linear effects become increasingly problematical as the gain-fiber is longer. Long gain-fibers are necessary with low brightness diode-laser pump sources currently available.

Prior-art fiber-lasers use primarily one of two different pumping arrangements. These arrangements are schematically illustrated in FIGS. 1 and 2 as arrangements 10 and 24, respectively.

In arrangement 10 of FIG. 1 fiber-amplifier stages 12 and 14 are in series and have an optical isolator 22 therebetween. Each amplifier stage includes a gain-fiber 16 having a doped core (not shown). An input signal, which may be a CW signal or a pulse signal, is introduced into the core of the gain-fiber of stage 12. Amplified output is delivered from the core of the gain-fiber of amplifier stage 14. The input signal may be from an oscillator, a seed-pulse source, or a previous amplifier stage. The output may be delivered for use or passed to a further stage of amplification. The arrangement is also suitable for pumping an oscillator, wherein a gain-fiber such as gain-fiber 16 would be terminated at each end thereof by a fiber Bragg grating (FBG).

Relatively low-power, for example between about 10 Watts (W) and 60 W, pump modules 18 are coupled to small-diameter fibers 20. By way of example, fibers 20 can be about 100 micrometers in (core) diameter. Fibers 20 are spliced to the gain-fiber in such a manner that the fiber-core carrying the signal being amplified is not affected, but the pump energy is coupled into the cladding of the gain-fiber. Outputs of several modules can be aggregated in each amplifier stage. Additional amplifier stages can be connected in series to increase total gain. However, adding stages of amplification does require optical isolators such as isolator 22. It is also evident that for pump modules having a power of only 10 W, 100 pump-modules and 100 fiber-splices would be required to couple 1 KW of pump power into the amplifier chain.

In arrangement 24 of FIG. 2 it is assumed that the output of arrays of several, for example twenty or more, emitters is aggregated and focused into the end of a gain-fiber 16. Here again, the arrangement can be an amplifier stage, or, if furnished with FBGs, an oscillator. At each end of gain-fiber 16, diode-laser radiation is collimated by optics (not shown), reflected from a dichroic beamsplitter 25, and then focused into the gain-fiber by a lens 26. At one end of the gain-fiber signal to be amplified is transmitted through the dichroic beamsplitter and focused in to the gain-fiber by the lens. At the other end of the gain-fiber, a diverging, amplified output beam is collimated by lens 26 and transmitted through the dichroic beamsplitter 25.

In both of the above described approaches optical pumping is limited by limitations of coupling the output of a plurality of diode-laser emitters into an optical fiber. An optical fiber has a fixed maximum cone of acceptance (NA) for radiation. Coupling is optimal when this cone is exactly filled (neither over-filled nor under-filled) with radiation. The power optically coupled depends on the brightness of the radiation exactly filling the cone.

One usual method of providing more radiation power than can be provided by a single diode-laser emitter, is to provide the radiation from a one-dimensional or two-dimensional array of such emitters. A one-dimensional array of diode-laser emitters is typically referred to as a diode-laser bar. The emitters have an emitting aperture about 1 micrometer (μm) high (in what is referred to as the fast-axis of the emitter) and a width from about 10 μm to over 100 μm (in what is referred to as the slow-axis of the emitter). The bars are usually about 1 centimeter (cm) long and between about 1 and 4 millimeters (mm) wide, with the emitters having a length in the width-direction of the bar and emitting apertures aligned in the slow-axis direction. There can be as many as 50 or more emitters in a one-centimeter long bar. The ration of the total width of emitter apertures to the distance between opposite end ones of the emitters is referred to as the fill-factor of the bar. The fill-factor can practically be as high a 90%. Two dimensional arrays of emitters can be formed by stacking a plurality of diode-laser arrays, one above, the other in the fast-axis direction.

As far as raw power is concerned, a diode-laser bar having a high fill-factor, for example equal to or greater than about 50% offers the lowest cost per watt ($/W) available for diode-laser output power. A problem, however, as far as brightness is concerned, is that the higher the fill-factor of a diode-laser bar the less bright the aggregate output of the bar will be.

Various optical arrangements, having various degrees of success, have been proposed or implemented for overcoming this problem. Most of these involve complicated combinations of prisms, lenses or polarization sensitive devices, and are relatively expensive and space consuming compared with a simple optical arrangement of a fast-axis collimating lens and a focusing lens that can be used to focus the output of a single emitter. This expense difference becomes increasingly burdensome when a plurality of such arrangements is required. There is a need for an alternate method and apparatus for using high-fill-factor diode-laser bars for optically pumping a fiber-laser or fiber-amplifier.

### SUMMARY OF THE INVENTION

The present invention is directed to providing multi-kilowatt average power and high peak power fiber-lasers and amplifiers powered by radiation from relatively inexpensive diode-laser bars. In one aspect, apparatus in accordance with the present invention comprises an optical gain-fiber having a doped-core surrounded by a cladding and a plurality of external-cavity optically-pumped semiconductor lasers (OPS-lasers). Each of the OPS-lasers is optically pumped by at least one diode-laser bar. An arrangement is provided for optically coupling the radiation from the output beams of the OPS-lasers into the cladding of the gain-fiber for energizing the doped-core of the gain-fiber.

In one embodiment of the invention, the optical coupling arrangement includes a lens arranged to focus the radiation from the plurality of OPS laser output beams into the cladding of the gain-fiber at one end thereof. In another embodiment of the invention, the optical coupling arrangement includes a lens and a delivery optical fiber having a core surrounded by a cladding. The lens is arranged to focus the radiation from the OPS-laser output-beams into the core of the delivery-fiber at one end thereof. An opposite end of the delivery fiber is arranged to couple the OPS laser radiation from the core thereof into the cladding of the gain-fiber.

In another aspect of the present invention the diode-laser bars can be high fill-factor diode-laser bars which have low brightness, but are relatively inexpensive. Only a simple single-element optic is required to concentrate the diode-laser radiation onto a gain structure of the OPS-laser. The OPS-laser converts this low-brightness pump-radiation from the diode-laser bar into single-mode, very high brightness pump-radiation for the gain-fiber.

The high brightness of the OPS-laser pump-radiation enables pumping double-clad gain-fibers having a relatively small cladding diameter compared with that of gain-fibers that are pumped directly with diode-laser radiation. This is very important for achieving average output power greater than 1 kW, or peak power greater than 10 kW, in a single mode fiber-laser.

Small cladding diameter provides that that the cladding-to-core area ratio in the gain-fiber cam be correspondingly reduced. This advantageously leads to short pump-radiation absorption length, thus mitigating above discussed nonlinear effects that set the limit to the average and peak power of a prior-art single mode fiber-laser. Fibers having a relatively small core-diameter, for example about 15 μm diameter, and made of phosphor-silicate glass can be used instead commonly used alumino-silicate fibers having a 25 μm core-diameter. Phosphor-silicate fibers are more resistant to “photo-darkening” which typically limits the lifetime of fiber-lasers. Additionally, the small clad-core area ratio provides that that ytterbium (Yb) doped fibers can be pumped “resonantly”, that is at a wavelength that is close to the generated wavelength. An example could be pumping in a 990 nanometers (nm) to 1020 nm wavelength band while emitting at a wavelength between about 1060 and 1090 nm. Low absorption relative to absorption at 915 nm or 976 nm radiation bands in Yb doped cores makes pumping essentially impossible with lower brightness pump beams. This is due to increased length required due to increased length of fibers and onset of above discussed nonlinear effects.

Resonant pumping minimizes quantum defect and, thus, heat released in the fiber. Such heat release leads to another fundamental limitation of power output possibility in prior-art single mode fiber-lasers. OPS-lasers have sufficient wavelength flexibility to facilitate resonant pumping. Because of the above discussed advantages, the inventive use of diode-pumped OPS-laser radiation for pumping fiber-lasers and fiber-amplifiers can provide fiber-lasers having CW or peak pulse-power levels well in excess of those achievable with prior-art direct diode-laser radiation pumped fiber-lasers to be provided in a cost efficient manner. Other advantages and embodiments of the present invention will be evident to those skilled in the art from the detailed of the present invention provided hereinbelow.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1 schematically illustrates one prior-art arrangement for pumping an optical gain-fiber wherein a plurality of diode-laser pump modules are coupled to a corresponding plurality of optical fibers, each thereof spliced to the cladding of the gain-fiber.

FIG. 2 schematically illustrates another prior art arrangement for pumping an optical gain-fiber wherein diode-laser radiation is focused into each end of an optic gain-fiber.

FIG. 3 schematically illustrates one preferred embodiment of an OPS-laser pumped fiber-laser in accordance with the present invention, wherein beams from a plurality of OPS-lasers are focused by a single lens into the cladding of an optical gain-fiber at one end thereof.

FIG. 3A is a view seen generally in the direction 3A-3A of FIG. 3 schematically illustrating the distribution of seven OPS-laser beams on the lens of FIG. 3.

FIG. 4 schematically illustrates one preferred embodiment of an OPS-laser pumped fiber-amplifier stage in accordance with the present invention, wherein radiation from a plurality of OPS-laser modules is coupled to a corresponding plurality of optical fibers, each thereof spliced to the cladding of a gain-fiber, with the each of the OPS-laser modules including a plurality of OPS-lasers beams therefrom being coupled to the corresponding optical fiber by a single focusing lens.

FIGS. 5A and 5B are respectively fast and slow-axis views schematically illustrating one example of an OPS-laser for use in an OPS-laser module in a fiber-laser in accordance with the present invention, the OPS-laser including a surface-emitting gain-structure surmounting a mirror structure with a diode-laser bar providing pump radiation for the OPS gain-structure and with light from the diode-laser bar being collimated in the fast-axis thereof and formed into a focal spot on the OPS-gain structure by a mirror having optical power only for the slow-axis of the diode-laser bar.

FIGS. 6A and 6B are graphs schematically illustrating one example of calculated distribution of radiation intensity in the fast- and slow-axes respectively for the focal spot (diode-laser radiation spot) of the laser of FIGS. 5A-B in which the mirror has a true cylindrical surface in the slow-axis.

FIGS. 7A and 7B are graphs schematically illustrating one example of calculated distribution of radiation intensity in the fast- and slow-axes respectively for the focal spot of the laser of FIGS. 5A-B in which the mirror has a parabolic surface in the slow-axis.

FIGS. 8A and 8B are respectively fast and slow-axis views schematically illustrating another example of an OPS-laser for use in an OPS-laser module in a fiber-laser in accordance with the present invention, similar to the OPS-laser of FIGS. 5A-B but wherein light from the diode-laser bar is directed onto the gain-structure by a reflective concentrator having a conical reflecting surface.

FIG. 9 is a graph schematically illustrating one example of calculated distribution of radiation intensity in the fast- and slow-axes respectively for diode-laser radiation spot of the laser of FIGS. 8A-B.

FIGS. 10A and 10B are graphs schematically illustrating one example of calculated distribution of radiation intensity in the fast- and slow-axes respectively for the diode-laser radiation spot of a laser similar to the laser of FIGS. 8A-B but wherein the concentrator has a reflective surface straight-tapered only in the slow-axis.

FIGS. 11A and 11B are respectively fast and slow-axis views schematically illustrating yet another example of an OPS-laser for use in an OPS-laser module in a fiber-laser in accordance with the present invention, similar to the OPS-laser of FIGS. 8A-B but wherein the reflective concentrator is replaced by a fast, aspheric cylindrical lens.

FIG. 12 schematically illustrates still another preferred embodiment of an OPS-laser pumped fiber-laser in accordance with the present invention, similar to the laser of FIG. 3 but wherein beams from pairs of OPS-lasers are polarization-combined by polarization-sensitive beam combiners into single beams focused by a single lens into the cladding of an optical gain-fiber at one end thereof.

FIG. 13 schematically illustrates a further preferred embodiment of an OPS-laser pumped fiber-laser in accordance with the present invention, similar to the laser of FIG. 3 but wherein beams from pairs of OPS-lasers are wavelength-combined by dichroic beamsplitters into single beams focused by a single lens into the cladding of an optical gain-fiber at one end thereof.

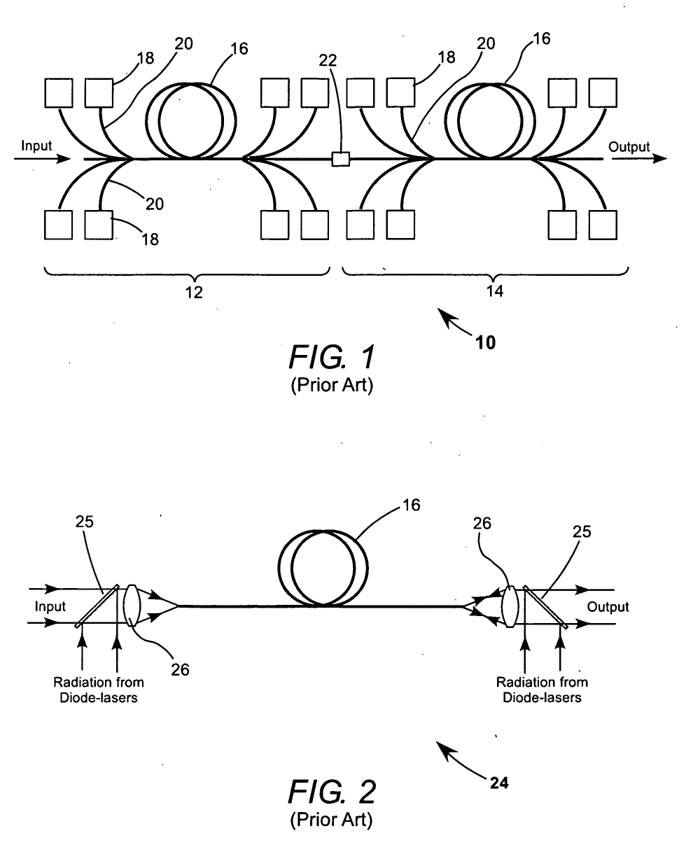

### DETAILED DESCRIPTION OF THE INVENTION

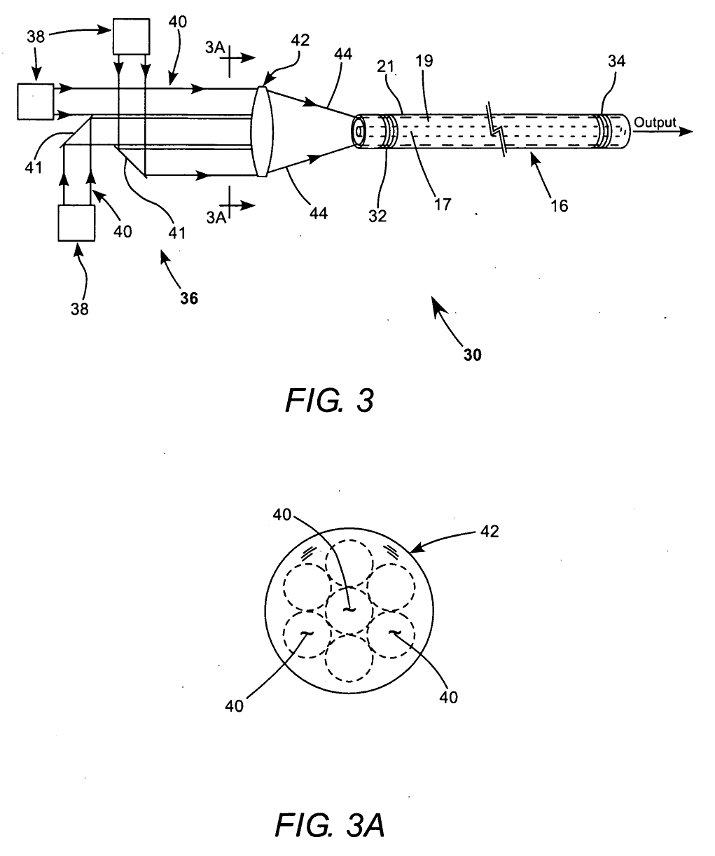

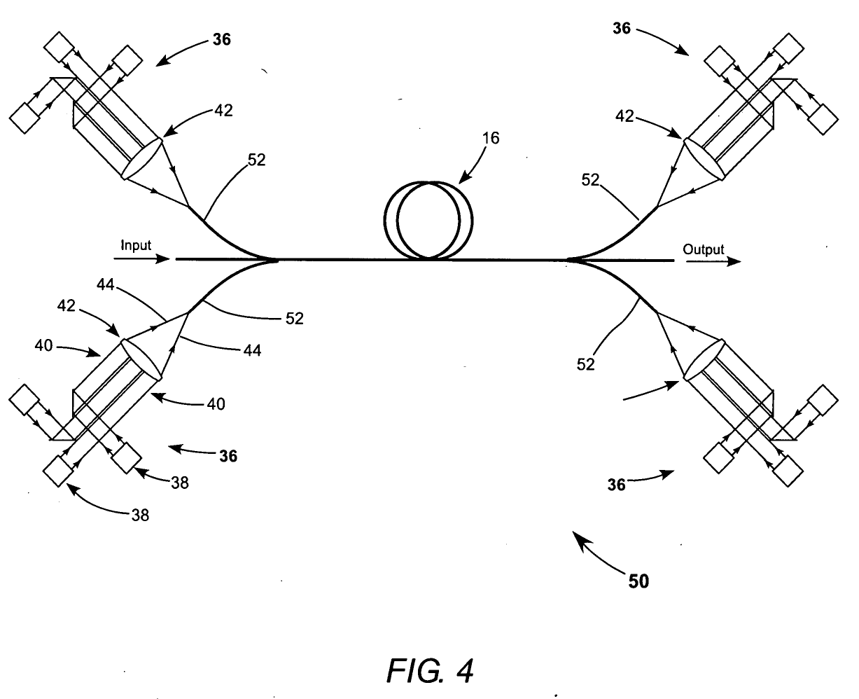

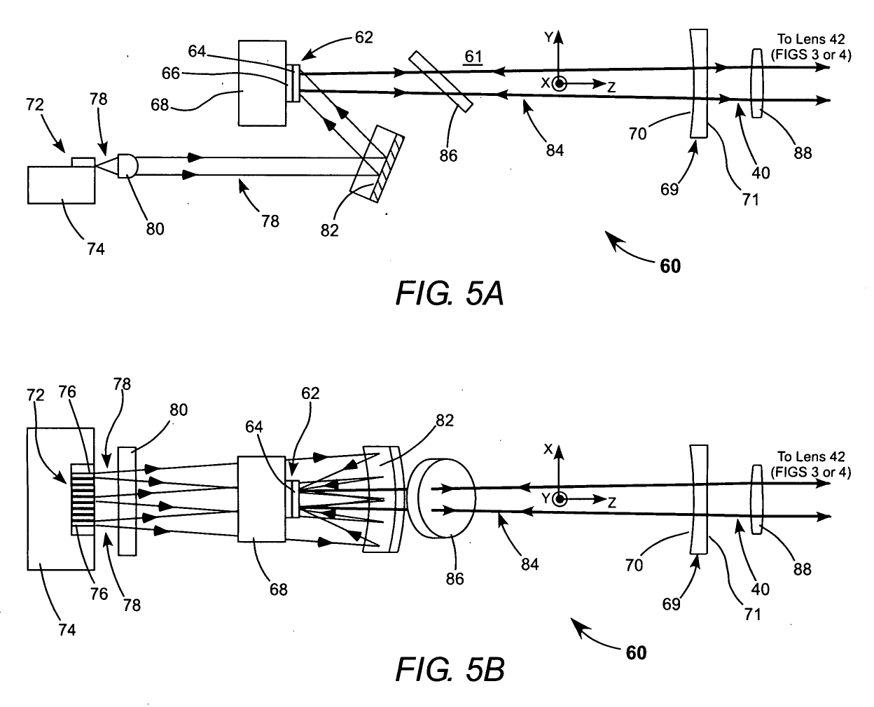

Referring again to the drawings, wherein like components are designated by like reference numerals, FIG. 3 and FIG. 3A schematically illustrate one preferred embodiment 30 of an OPS-laser pumped fiber-laser in accordance with the present invention. Laser 30 includes a “double-clad” optical gain-fiber 16 having a doped core 17 surrounded by an inner core 19 which is surrounded by an outer core 21. A laser resonator is formed in the gain-fiber between fiber Bragg gratings (FBGs) 32 and 34.

Optical pump radiation is provided by a pump module 36 including plurality of external-cavity, surface-emitting, semiconductor lasers (OPS-lasers) 38. Each laser delivers a beam of radiation 40 preferably in a single lateral mode or at least a “low-M²” (for example M²<2) mode. The beams are directed parallel to each other, here, by an arrangement of turning mirrors 41, to a positive lens 42. Radiation from all of the beams is focused by lens 42, as indicated by converging rays 40, into inner cladding 19 of gain-fiber 16, with a small portion, of course, directed into core 17. The beams are preferably collimated and in fact a single lateral mode OPS-laser beam can be collimated to close to the diffraction limit using a relatively simple commercial catalog lens element. Alternatively “as-delivered” OPS-laser beams have sufficiently low divergence that a collimating lens may be omitted. In the arrangement of laser 30 FBG 32 would be transparent to pump radiation and fully reflective for laser radiation. FBG 34 would be partially reflective and partially transmissive for laser radiation.

FIG. 3A schematically depicts one example of “tiling” of beams 40 on lens 42. Here, for simplicity of illustration, only seven beams are depicted (by dashed circles) in a non-overlapping, cruciform pattern. In practice, as many as 250 beams having M²<2 may be directed onto lens 42 and focused into an optical gain-fiber having a cladding diameter of about 100 μm and a NA of about 0.22. The beams may be arranged in either an overlapping or non-overlapping pattern. It is possible to provide beam shaping optics between each OPS laser and the lens to optimize tiling. Assuming a relatively modest output power of about 30 W for a single-chip OPS laser, it is possible to couple as much as 7.5 kW of radiation into the above discussed 100 mm-diameter, 0.22-NA gain-fiber. An even greater power may be directed into the gain-fiber if more than 250 OPS beams are directed onto lens 42 by polarization-combining beams or wavelength-combining beams.

It should be noted, here that the pumping arrangement discussed above with gain-fiber 16 serving as an oscillator, can equally well be applied to a stage of fiber-amplification, for example by omitting FBGs 32 and 34 from the gain-fiber. It would be necessary, however, to direct pump light into the gain-fiber by reflection from or transmission through a dichroic beamsplitter in the manner described above with reference to FIG. 2, to permit coupling of the input into and output out of the gain-fiber.

It should also be noted that the subject invention is not limited to conventional double clad fibers where there is a solid doped core and solid annular cladding material. For example, certain fibers are formed where the doped core is annular in configuration. Further, it is known to form the cladding region with air holes. The latter fibers are often referred to as photonic crystals. It is intended the references to doped cores and claddings in the claims cover these variants.

FIG. 4 schematically illustrates one preferred embodiment 50 of an OPS-laser pumped fiber-amplifier stage in accordance with the present invention. Here, a plurality of OPS-laser pump modules 36 is provided having the same general configuration as module 36 of FIG. 3. Beams 40 of each module are focused by a lens 42 into one end of a corresponding optical fiber 52, the other end of which is coupled to the gain-fiber. Any well known means for coupling pump radiation form the plurality of fibers into to the cladding of the gain-fiber, such as an N-to-1 coupler may be employed without departing from the spirit and scope of the present invention. Only four OPS-laser pump modules are depicted in FIG. 4 for simplicity of illustration.

On a first consideration it would seem to be prohibitively expensive to use OPS-lasers for fiber-laser pumping instead of diode-lasers, as diode-lasers are required to optically pump the OPS-lasers and the optical efficiency of the OPS-lasers is considerably less than 100%. It has been determined, however, that an OPS-laser suitable for use in an OPS-laser pump module in accordance with the present invention can be pumped by an inexpensive high-power, high fill-factor diode-laser bar that would be totally unsuitable for prior-art diode-laser pumping arrangements, at least because of insufficient brightness. Further it has been determined that an optical arrangement for directing the pump radiation from the high fill-factor diode-laser bar onto the OPS chip can be easily produced inexpensively in volume.

FIG. 5A and FIG. 5B schematically illustrate one preferred example 60 of an OPS-laser suitable for use in an OPS-laser pump module in accordance with the present invention, which is optically pumped with radiation from a high fill-factor diode-laser bar 72. OPS-laser 60 includes an OPS-structure (OPS chip) 62 including a surface-emitting gain-structure 64 surmounting a mirror-structure 66. The OPS-chip is supported in thermal contact with a heat sink 68. A stable laser resonator 61 is formed between mirror-structure 66 of the OPS chip and a (partially transmitting) mirror-coated concave surface 70 of an optical element 69.

The high fill-factor diode-laser bar 72 preferably has a fill-factor greater than or equal to about 50%. Diode-laser bar 72 supplies optical pump-radiation for the OPS-laser, as noted above, and is supported in thermal contact with a heat sink 74. Emitters 76 of the diode-laser bar each deliver a beam 78. Only three beams 78 are depicted in FIG. 5B for simplicity of illustration. A microlens 80 having optical power only in the fast-axis of the diode-laser bar collimates beams 78 in the fast-axis of the diode-laser bar. This fast-axis corresponds to the Y-axis of the OPS laser depicted in FIG. 5A. The slow-axis of the diode-laser bar, corresponding to the X-axis depicted in FIG. 5B is perpendicular to the slow-axis.

Fast-axis collimated beam 78 is incident on a mirror 82, which has optical power only in the slow-axis of the diode-laser bar. Mirror 82 focuses each beam 38 in the slow-axis into a spot on gain-structure 64 of the OPS chip. Outer rays of the fan of rays directed to the chip can have incidence angles up to about 70°. The spot is about square in shape and in practical examples may have dimensions about 1.0 millimeters (mm) by about 1.0 mm. The spots from each beam overlap. A commercially available 50% fill-factor bar having 25 emitters each with a width of about 200 μm in the slow-axis can deliver about 100 W of total power into the 1.0 mm spot. A true cylindrical (part-circular cross-section) surface will provide effective slow-axis focusing. An example is discussed further hereinbelow.

Optical pumping of gain-structure 64 causes a beam of laser radiation 84 to circulate in resonator 61, generally along the Z-axis. Optionally a birefringent filter (BRF) 86 or some other wavelength selective element can be provided for selecting a wavelength of the circulating radiation from within the gain-bandwidth of gain-structure 64. A portion of the circulating radiation is transmitted by mirror 70 as output beam 40. Preferentially the resonator is configured such that the beam is delivered as a single-lateral-mode beam. As delivered from mirror 70 in the optical element configuration depicted the beam would have a diameter of about 1000 μm and divergence on the order of about 1.0 milliradians, dependent on the resonator length. Optionally a lens 88 is provided for collimating beam 40. The function of lens 88 could be provided to some degree by replacing plane surface 71 of element 60 with a convex surface.

It should be noted here that only a sufficient description of an external-cavity, optically-pumped, surface-emitting semiconductor laser is provided herein to enable one skilled in the art to understand principles of the present invention. A more detailed, description of an OPS laser is provided in U.S. Pat. No. 6,097,742, granted to Spinelli et al., assigned to the assignee of the present invention, and the complete disclosure of which is hereby incorporated herein by reference.

By way of example for an optimized transmission of mirrored surface 70, and a pump power of about 100.0 W delivered to gain-structure 64, output beam 40, would have a power of about 40.0 W. The brightness of beam 40 in a single lateral mode (M² about 1.1) would be about 600 (six-hundred) times greater than the brightness of the pump radiation. This would allow the beam to be collimated to near the diffraction limit, with the aggregate of a plurality of the collimated beams being focusable to a near diffraction-limited spot size.

It should be noted here that while only one diode-laser bar is depicted for delivering pump-radiation, it is possible to deliver pump radiation from two or more diode-laser bars. Ultimately, the deliverable power will be limited by cooling limitations of the gain-structure.

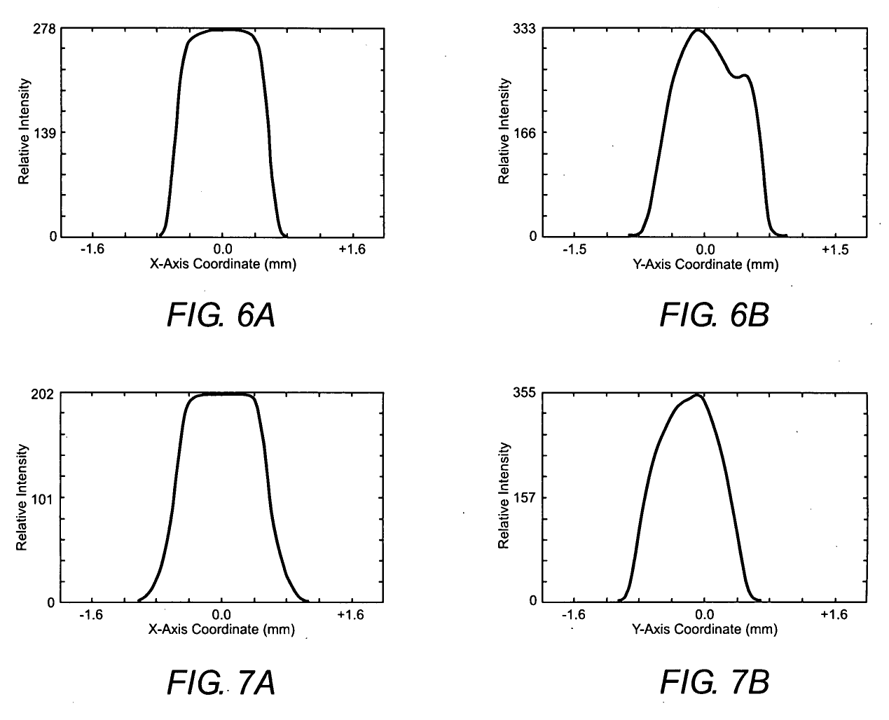

FIG. 6A and FIG. 6B are graphs schematically illustrating the calculated intensity distribution of pump radiation in the X-axis and Y-axis respectively in one example of the laser of FIGS. 5A and 5B wherein mirror 82 has a true cylindrical surface having a X-axis radius of curvature (ROC) of 6.5 mm. Diode-laser bar 72 is assumed to be a 50% fill-factor bar having 25 emitters. Divergence in the slow-axis is assumed to be about 4° half-angle. The Y-axis height of beam 78 leaving collimating lens 80 is slightly less than 1 mm at the 1/e² points. The diode-laser bar is located 30.0 mm from mirror 82. Mirror 82 is assumed to be located 6.5 mm from the gain-structure. The angle of incidence of beam 78 on mirror 82 is assumed to be 20°. Note that the spot width in the Y-axis is somewhat wider in the Y-axis than in the X-axis.

FIG. 7A and FIG. 7B are graphs schematically illustrating the calculated intensity distribution of pump radiation in the X-axis and Y-axis respectively in one example of the laser of FIGS. 5A and 5B with similar assumptions to the assumptions of FIGS. 6A-B with an exception that mirror 82 has a parabolic surface in the X-axis of a form y(x)=c/2*x², where y is the mirror sag, x is the coordinate perpendicular to the longitudinal axis of the reflector and c is the inverse effective radius of curvature. This seems to provide a somewhat smaller and more symmetrical calculated pump-spot than that of the true cylinder mirror calculation.

An OPS-pumped laser in accordance with the present invention, because of the very high brightness of the OPS-laser beam is particularly suited to resonant pumping wherein the pump-radiation is selected to have a wavelength close to the emitting wavelength (gain-wavelength) of the gain-fiber. By way of example in Yb-doped gain-fiber, i.e., a fiber having a Yb-doped core, pump-radiation may have a wavelength between about 990 nanometers (nm) and 1020 nm and the emission wavelength could be selected between about 1060 nm and 1090 nm. The pump wavelength can be select by selecting a suitable composition for active layers of the gain-structure with fine selection using BRF 86. The emission wavelength can be selected by narrow bandwidth FBGs in the gain-fiber. This resonant pumping lowers the quantum defect of the pumping and produces less heat due to absorbed, unconverted pump radiation.

While absorption for pump radiation is low in the region between about 990 nm and 1020 nm relative to absorption peaks at 915 nm or 976 nm, this is compensated by the high brightness of the OPS-laser pump radiation. Resonant pumping in Yb-doped gain-fibers is essentially impossible with lower brightness diode-laser pump-beams.

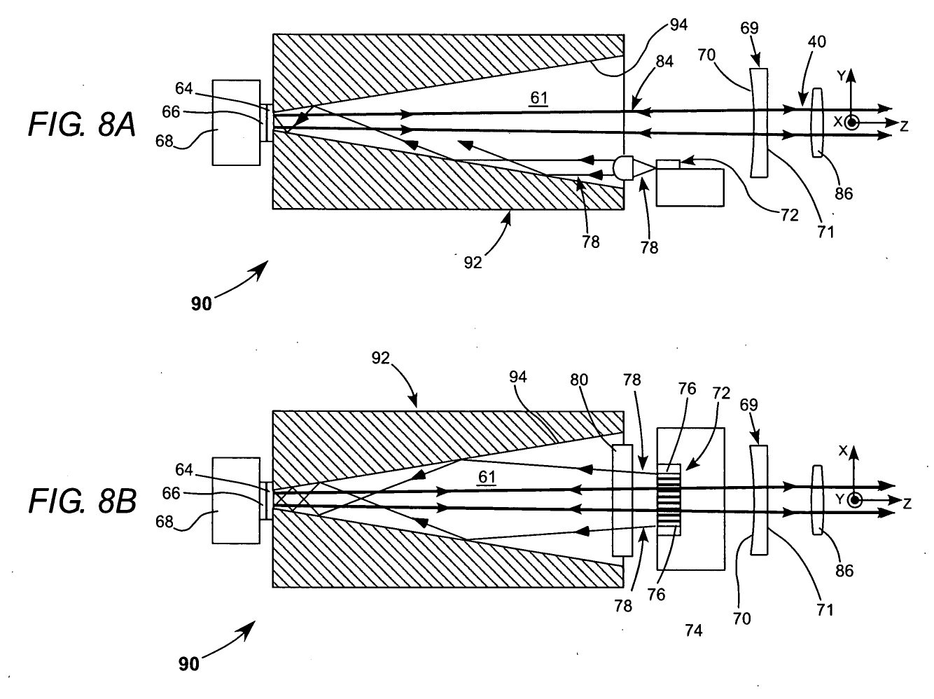

FIG. 8A and FIG. 8B schematically illustrate another example 90 of an OPS-laser suitable for use in an OPS-laser pump module in accordance with the present invention. OPS-laser 90 is similar to laser 60 of FIGS. 5A-B with an exception that mirror 90 is replaced by a reflective concentrator 92 having an internal conical-tapered reflective surface 94. Radiation in beams 78 from emitters 76 of diode-laser bar 72 is concentrated by multiple reflections from the reflecting surface of the concentrator. The angle of incidence of radiation on the reflective surface increases after every reflection. Gain chip 34, because of the relatively high refractive index (greater than 3.0) of semiconductor layers therein can accept radiation at incidence angles up to about 70°. The overall width of radiation from diode-laser bar in the slow-axis can be compressed from about 10.0 mm at the emitter plane of the bar to less than about 1.0 mm on gain-structure 64.

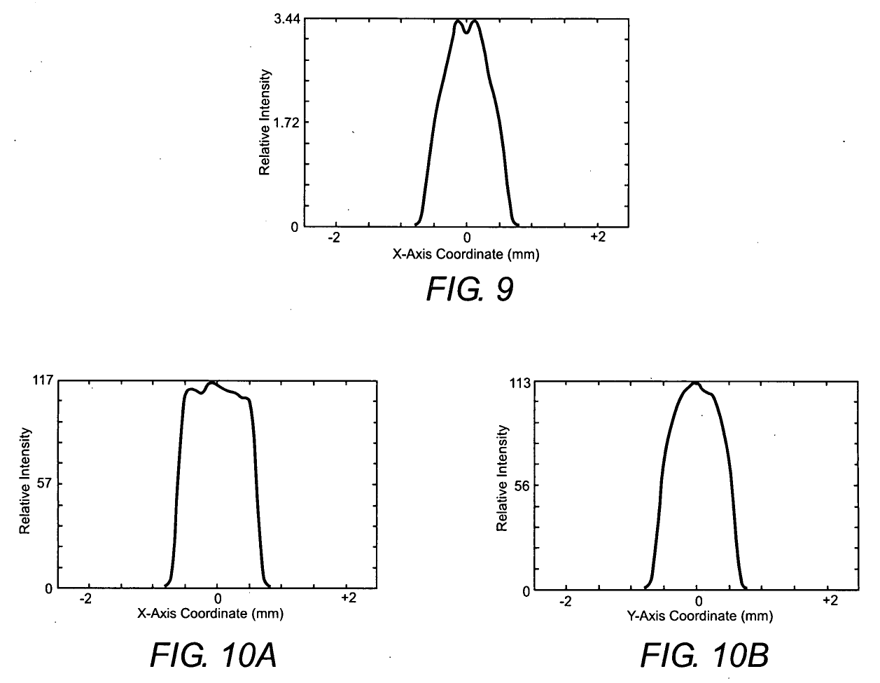

FIG. 9 is a graph schematically illustrating the calculated intensity distribution of pump-radiation on gain structure 64, in the X-axis, in one example of the laser of FIGS. 8A and 8B. The pump-radiation spot on the chip is circular and has a diameter of about 1.0 mm. The distribution of radiation is essentially symmetrical, with the Y-axis intensity distribution being substantially the same as the X-axis intensity distribution. Diode-laser bar 72 is assumed to have the parameters discussed above with reference to FIGS. 6A-B. The Y-axis height of beam 78 leaving collimating lens 80 is slightly less than 1.0 mm at the 1/e² points. Conical reflecting surface 94 of concentrator 92 is assumed to have a taper half-angle of 5°, with a 1.0 mm-diameter exit aperture at gain structure 64. The diode-laser bar is located 50.0 mm from gain-structure 64 and 2.0 mm below the longitudinal axis of resonator 61. Those skilled in the art will recognize, without further detailed description or illustration, that a more concentrated pump spot may be obtained by providing a parabolic reflecting surface in concentrator 92 of OPS-laser 90.

Those skilled in the art to which the present invention pertains will recognize that the cost of fabricating a concentrator such as concentrator 92, all else being equal, will be somewhat greater than the cost of fabricating a simple true-cylinder reflector such as mirror 82 of laser 60. The cost difference may be somewhat less for a concentrator tapered only in the slow-axis (X-axis). The calculated intensity distribution in the pump spot, in the slow-axis and fast-axis, for such a one-dimensional tapered concentrator is schematically illustrated in the graphs FIG. 10A and FIG. 10B, respectively. All other assumptions in this case are the same as the assumptions for the conical concentrator case of FIG. 9. The pump-spot, here, is about square and it can be seen that in general the intensity distribution is comparable to that provided by the true-cylindrical lens of OPS-laser 60 of FIGS. 5A-B.

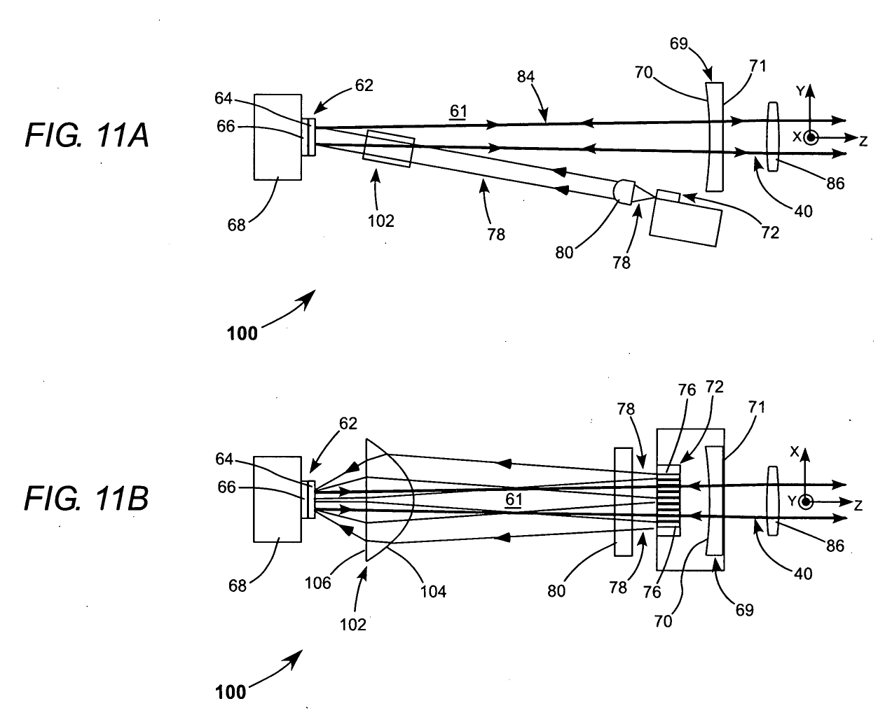

FIG. 11A and FIG. 11B schematically illustrate yet another example 100 of an OPS-laser suitable for use in an OPS-laser pump-module in accordance with the present invention. OPS-laser 100 is similar to laser 60 of FIGS. 5A-B with an exception that cylindrical mirror 82 of laser 60 is replace in laser 100 by a lens 102 having a highly aspheric (entrance) surface 104 and a plane (exit) surface 106. The lens has optical power in the slow-axis only. Given a diode-laser bar having parameters discussed above in connection with the intensity distribution calculations of FIGS. 6A and 6B, with lens 102 spaced at (18 mm) mm from the diode-laser bar, and with lens 102 spaced at 2.9 mm from gain-structure 64, a suitable surface specification for surface 104 would be approximated by a polynomial:

Y(t)=5.7576727537 t²+1.5802789316 t⁴−1.0400024281 t⁶+6.0083075238 t⁸−3.0265843283 t¹⁰−20.2943710586 t¹²+30.1437988598 t¹⁴−12.2092446403 t¹⁶ (1)

where t=X/(7.5 mm) X in mm, Y in mm and X has values between −6.5 mm and 6.5 mm. The center thickness of the lens is 5.5 mm, and the polynomial assumes that the lens is made from S-TIH53 glass available from Ohara Corporation of Branchburg, N.J. The intensity distribution on gain-structure 64 would be about the same as could be achieved with the cylindrical reflective mirror of FIGS. 5A-B.

It should be noted, here, that the concentrator and lens arrangements for directing diode-laser radiation are discussed above primarily for completeness of description. The cylindrical lens reflector arrangement of laser 60 for directing the diode-laser radiation onto the gain-structure of the OPS-laser is the least expensive, and more than adequate for most applications.

An OPS-laser typically has somewhat limited optical conversion efficiency, for example, between about 40% and 50% in the arrangement of laser 60. This is mitigated, however, in the present invention by the simplicity of the OPS-resonator, the relatively low cost of high fill-factor, low brightness diode-laser bars, and the simplicity and low cost of optics for directing the radiation from the bars.

One option for coupling higher OPS-laser power into a gain-fiber includes using OPS-lasers that include two or more-gain chips. OPS-lasers including two, independently pumped OPS-chips are described in the above-referenced Spinelli et al. patent. Another option is to polarization-combine pairs of OPS-laser beams having different polarization orientations into a combined beam, and direct the combined beam to lens 42. Yet another option is to wavelength-combine beams having different wavelengths using dichroic combiners.

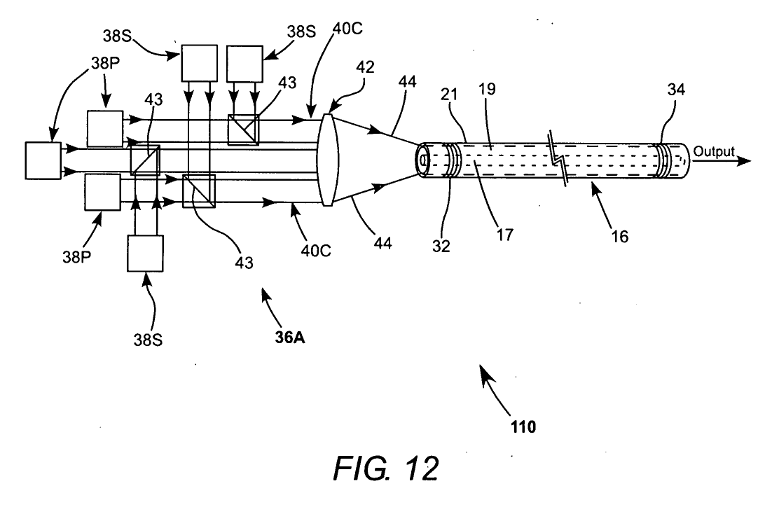

By way of example FIG. 12 schematically illustrates still another embodiment 110 of an OPS-laser pumped fiber-laser in accordance with the present invention. Laser 110 is similar to laser 30 of FIG. 3 with an exception that pump module 36 of laser 30 is replaced in laser 110 with a pump module 36A including three OPS-lasers 38P and three OPS-lasers 38S. A beam for each OPS-laser 38P is combined by a beam from each OPS-laser 38S by an (internal) polarization-sensitive beam combiner 43 to provide a combined beam 40C. Here it should be noted that the P and S designation of the OPS-lasers refers to the polarization orientation of the beams therefrom with respect to the polarization-selective beam combiners. The P and S orientations are perpendicular to each other.

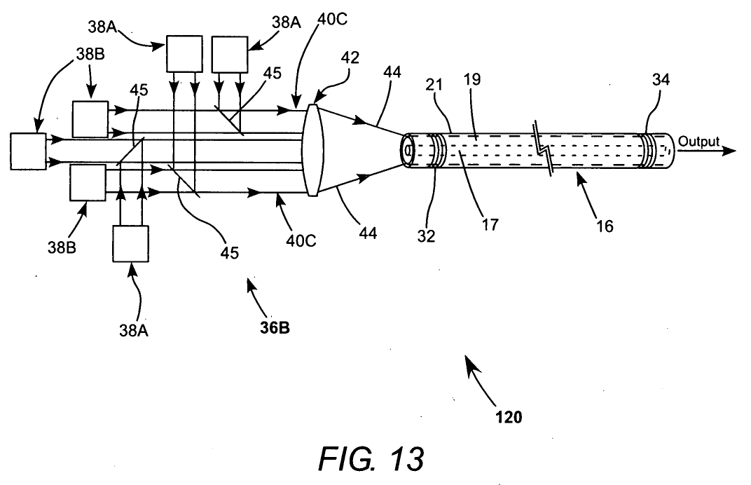

FIG. 13 schematically illustrates a further embodiment 120 of an OPS-laser pumped fiber-laser 120 in accordance with the present invention. Laser 120 is similar to laser 30 of FIG. 3 with an exception that pump module 36 of laser 30 is replaced in laser 120 with a pump module 36B including three OPS-lasers 38A emitting radiation having a wavelength λ₁, and three OPS-lasers 38B emitting radiation having a wavelength λ₂. A beam for each OPS-laser 38A is combined by a beam from each OPS-laser 38B by a dichroic beam combiner 45 to provide a combined beam 40C including wavelengths λ₁ and λ₂. The wavelengths should correspond with absorption bands of the doped core 17 of gain-fiber 16. By way of example, in the case of a Yb-doped fiber the wavelengths could be about 915 nm and about 976 nm, or more closely spaced wavelengths within the 990 nm to 1020 nm resonant pumping band.

Using wavelength-combining, more than two beams may be combined into a single beam and is not restricted to beam combining using dichroic beam-combiners. Those skilled in the art will recognize without further detailed description or illustration that wavelength-combining of beams is can be effected using diffraction gratings or prisms. Any such means may be used alone or in combination without departing from the spirit and scope of the present invention.

The cost of the inventive fiber-laser pumping scheme is believed to be at least comparable with, and possibly even be less than cost of direct diode-laser pumping. The cost of the OPS-laser resonator and the simple diode-laser bar pumping arrangement for the OPS laser compares with the cost of high brightness single emitters with multiple combiners, or diode-laser bars with complex and expensive combiner optics, that are required for prior-art direct diode-laser pumping of a gain-fiber. In a sense, the OPS-laser acts as a “brightness converter” for low quality light from the diode-bars. The brightness of the OPS-laser radiation can be greater than 500 times the brightness of radiation from a 50% fill-factor diode-laser bar. Because of this, the use of the high quality OPS-laser beams for optically pumping gain-fibers can provide fiber-lasers having CW of peak pulse-power levels well in excess of those achievable with prior-art direct diode-laser radiation pumped fiber-lasers, and with comparable or longer lifetime.

In summary, the present invention is described above in terms of preferred and other embodiments. The invention is not limited, however, to the embodiments described and depicted. Rather, the invention is limited only by the claims appended hereto.

What is claimed is:

1. Optical apparatus, comprising:
an optical gain-fiber having a doped-core surrounded by a cladding;
a plurality of external-cavity optically-pumped semiconductor lasers (OPS-lasers) each thereof optically pumped by a diode-laser bar and each thereof arranged to deliver an output beam of laser radiation; and
an arrangement for optically coupling the radiation from the output beams of the OPS-lasers into the cladding of the gain-fiber for energizing the doped-core of the gain-fiber.

2. The apparatus of claim 1, wherein the optical coupling arrangement includes a lens arranged to focus the radiation from the plurality of OPS-laser output beams into the cladding of the gain-fiber at one end thereof.

3. The apparatus of claim 1, wherein the optical coupling arrangement includes a lens and a delivery optical fiber having a core surrounded by a cladding, and wherein the lens is arranged to focus the radiation from plurality of OPS laser output beams into the core of the delivery fiber at one end thereof, and an opposite end of the delivery fiber is arranged to couple the OPS-laser radiation from the core thereof into the cladding of the gain-fiber.

4. The apparatus of claim 1 wherein the diode-laser bars pumping the OPS-lasers have a fill-factor greater than or equal to about 50%.

5. The apparatus of claim 4 wherein the diode-laser bar has a slow-axis and a fast-axis perpendicular to the slow-axis wherein the OPS laser includes an OPS-chip having a gain-structure and wherein radiation from the diode-laser bar is concentrated onto the gain structure by a mirror having positive optical power only in the slow-axis of the diode-laser bar.

6. The apparatus of claim 4 wherein the diode-laser bar has a slow-axis and a fast-axis perpendicular to the slow-axis wherein the OPS laser includes an OPS-chip having a gain-structure and wherein radiation from the diode-laser bar is concentrated onto the gain structure by a lens having positive optical power only in the slow-axis of the diode-laser bar.

7. The apparatus of claim 4, wherein the diode-laser bar has a slow-axis and a fast-axis perpendicular to the slow-axis. Wherein the OPS laser includes an OPS-chip having a gain-structure and wherein radiation from the diode-laser bar is concentrated onto the gain structure by multiple reflections from a reflective concentrator surface tapered in at least the slow-axis of the diode laser bar.

8. The apparatus of claim 7, wherein the reflective concentrator surface is a conical surface tapered in both the fast-axis and slow-axis of the diode-laser bar.

9. The apparatus of claim 7, wherein the tapered surface is a parabolic surface.

10. The apparatus of claim 1, wherein the gain-fiber has a Yb-doped core providing a gain-wavelength between about 1060 nanometers and 1090 nanometers, and the radiation in the OPS-laser beams has a wavelength between about 990 and 1020 nm.

11. The apparatus of claim 1 wherein the gain-fiber is a Yb-doped gain-fiber and wherein the FBGs define an emitting wavelength of the gain-fiber between about 1060 nanometers and 1090 nanometers, and the laser radiation in the OPS-laser beams has a wavelength which one of about 915 nm and 976 nm.

12. The apparatus of claim 1, wherein the beams of OPS-laser radiation have different wavelengths and two or more different wavelength beams are wavelength-combined into a single beam before being coupled into the cladding of the gain-fiber.

13. The apparatus of claim 1, wherein the beams of OPS-laser radiation have different polarization orientations and two different-polarization-orientation beams are wavelength-combined into a single beam before being coupled into the cladding of the gain-fiber.

14. Optical apparatus, comprising:
an optical gain-fiber having a doped-core surrounded by a cladding;
a plurality of external-cavity optically-pumped semiconductor lasers (OPS-lasers) each thereof optically pumped by a diode-laser bar and each thereof arranged to deliver an output beam of laser radiation; and
a lens arranged to focus the radiation from the plurality of OPS-laser output beams into the cladding of the gain-fiber at one end thereof.

15. The apparatus of claim 14 wherein the gain-fiber includes first and second fiber Bragg gratings (FBGs) spaced apart to form a laser resonator in the gain-fiber.

16. The apparatus of claim 15 wherein the gain-fiber is a Yb-doped gain-fiber and wherein the FBGs define an emitting wavelength of the gain-fiber between about 1060 nanometers and 1090 nanometers, and the laser radiation in the OPS-laser beams has a wavelength between about 990 nanometers and 1020 nanometers.

17. The apparatus of claim 15 wherein the gain-fiber is a Yb-doped gain-fiber and wherein the FBGs define an emitting wavelength of the gain-fiber between about 1060 nanometers and 1090 nanometers, and the laser radiation in the OPS-laser beams has a wavelength which one of about 915 nm and 976 nm.

18. The apparatus of claim 14, wherein the diode-laser bar has a slow-axis and a fast-axis perpendicular to the slow-axis wherein the OPS laser includes an OPS-chip having a gain-structure and wherein radiation from the diode-laser bar is concentrated onto the gain structure by a mirror having positive optical power only in the slow-axis of the diode-laser bar.

19. Optical apparatus, comprising:
an optical gain-fiber having a doped-core surrounded by a cladding;
a plurality of external-cavity optically-pumped semiconductor lasers (OPS-lasers) each thereof optically pumped by a diode-laser bar and each thereof arranged to deliver an output beam of laser radiation;
a lens
a delivery optical fiber having a core surrounded by a cladding; and
wherein the lens is arranged to focus the radiation from plurality of OPS-laser output beams into the core of the delivery fiber at one end thereof and an opposite end of the delivery fiber is arranged to couple the OPS-laser radiation from the core thereof into the cladding of the gain-fiber.

20. A method of pumping a fiber laser or fiber amplifier, said fiber laser or fiber amplifier including a gain fiber having a doped region surrounded by a cladding region, said method comprising the steps of:
generating a first pump beam from an optically pumped semiconductor (OPS) laser; and
directing the first pump beam into the gain fiber.

21. A method of pumping as recited in claim 20 wherein the step of generating the first pump beam is performed by generating a second pump beam from a diode laser bar and focusing the second pump beam onto a semiconductor chip within the OPS laser.
